(19) United States
(12) Patent Application Publication
(10) Pub. No.: US 2009/0083169 A1
(43) Pub. Date: Mar. 26, 2009

(54) FINANCIAL OPPORTUNITY INFORMATION OBTAINMENT AND EVALUATION

(75) Inventor: Robert J. Ortega, Moravian Falls, NC (US)

Correspondence Address: AMIN, TUROCY & CALVIN, LLP, 127 Public Square, 57th Floor, Key Tower, CLEVELAND, OH, 44114, US

(73) Assignee: WACHOVIA CORPORATION, Charlotte, NC (US)

(21) Appl. No.: 11/861,950

(22) Filed: Sep. 26, 2007

(51) Int. Cl. G06Q 40/00

(52) U.S. Cl. 705/35

(57) ABSTRACT

Often times, smaller financial opportunities are not pursued due to their size. Information concerning financial opportunities is collected automatically and analyzed to determine opportunities that should be pursued. In addition, entities that relate to financial opportunities can make requests to be pursued by a particular body. A decision is made if an analyzing body should pursue the financial opportunity or if it should be referred to another body.

### CROSS-REFERENCE

This application relates to attorney docket application no. WB2007022015/WACHP115US entitled “PRODUCT AND SERVICE MANIPULATION FOR OPPORTUNITY PURSUIT”. The entirety of which is incorporated by reference herein.

This application relates to attorney docket application no. WB2007022017/WACHP116US entitled “ECONOMIC OPPORTUNITY PURSUIT MANAGEMENT AND PRESENTATION GENERATION”. The entirety of which is incorporated by reference herein.

This application relates to U.S. patent application Ser. No. 11/832,600 entitled “ONLINE ORIGINATION MACHINE” filed on Aug. 1, 2007. The entirety of which is incorporated by reference herein.

### TECHNICAL FIELD

The subject specification relates generally to information obtainment and evaluation and in particular information to obtainment and evaluation in view of a financial opportunity.

### BACKGROUND

Recent developments in computer technology allow for mass dissemination of information. Different mediums enable one entity to gain a vast amount of details in a relatively short amount of time. Mediums can have different configurations depending on a purpose of information to be disclosed. Pointed mediums transmit information to targeted users (e.g., sending an e-mail message with an attachment to a set number of individuals) while general mediums, such as message boards, allow virtually anyone to view disclosed information.

One medium that enables large amounts of information communication is a data network commonly referred to as “the Internet”. The Internet provides a number of websites that can be engaged by viewers through an Internet connection. In addition to providing information, websites hold files that can be downloaded to a storage medium. Users can create websites for a wide range of purposes with different types of information and capabilities. Individual people can express personal thoughts, experiences, beliefs, etc. through publishing information through a website. Academic institutions can place publications upon their websites to highlight work accomplished by faculty members.

Corporate entities can employ websites to achieve different goals; one industry that utilizes the Internet is banking/lending. Financial institutions allow users to manage fiscal accounts through company-operates websites. Commonly, users log-on to a financial institution website and manipulate funds in a personal account. For instance, a user can view an online credit card statement to determine how much is owed upon an account. Upon learning of an owed amount, a user can write a personal check to the financial institution and send the check through a postal service.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Conventionally, large financial institutions engage in hefty business transactions, such as supplying a loan to a major company. This is commonly done by having a team of brokers gathering information, evaluating the gathered information, and determining if a transaction should be engaged. However, small transactions, obscure transaction, transactions outside of a typical practice area, etc. are often not pursued since these transactions typically require a large amount of resources in order to gain a relatively small financial gain. Since qualified brokers are in relatively short supply, it is generally viewed that dedicating brokers to large and familiar transactions will yield higher profits for an institution while other financial deals are not pursued.

The disclosed innovation allows for tasks that are classically performed by brokers to be completed automatically. Information is gathered from a plurality of sources and the gathered information is evaluated in order to determine if a financial opportunity is to be pursued. A financial opportunity is then pursued, referred to another entity, discarded, designated for watching, etc. Ultimately, a presentation can be generated and a team assembled to achieve the financial opportunity (e.g., close a profitable fiscal deal).

The disclosed innovation goes against current market trends and developments. Determining financial opportunities to pursue is performed by people due to the importance of a possible outcome (e.g., a transaction becoming profitable, a company taking a loss on a financial deal, etc.). For instance, in a lending institution, thousandths of percentage points can be a difference between having a deal become profitable and having a deal become a severe loss. Since small details can become important, it seems illogical to automate decision making with regard to transactions that should be pursued. However, thorough careful collection and analysis (e.g., use of a semantic search), enough quality fiscal possibilities can be pursued to make practicing the innovation profitable and thus beneficial.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative financial opportunity evaluation system in accordance with an aspect of the subject specification.

FIG. 2 illustrates a representative collection component in accordance with an aspect of the subject specification.

FIG. 3 illustrates a representative analysis component in accordance with an aspect of the subject specification.

FIG. 4 illustrates a representative financial opportunity evaluation system with a recommendation component and selection component in accordance with an aspect of the subject specification.

FIG. 5 illustrates a representative financial opportunity pursuit system in accordance with an aspect of the subject specification.

FIG. 6 illustrates a representative financial opportunity determination methodology in accordance with an aspect of the subject specification.

FIG. 7 illustrates a representative logic alteration methodology in accordance with an aspect of the subject specification.

FIG. 8a illustrates a first part of a representative financial opportunity pursuit methodology in accordance with an aspect of the subject specification.

FIG. 8b illustrates a second part of a representative financial opportunity pursuit methodology in accordance with an aspect of the subject specification.

FIG. 8c illustrates a third part of a representative financial opportunity pursuit methodology in accordance with an aspect of the subject specification.

FIG. 9 illustrates an example of a schematic block diagram of a computing environment in accordance with the subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

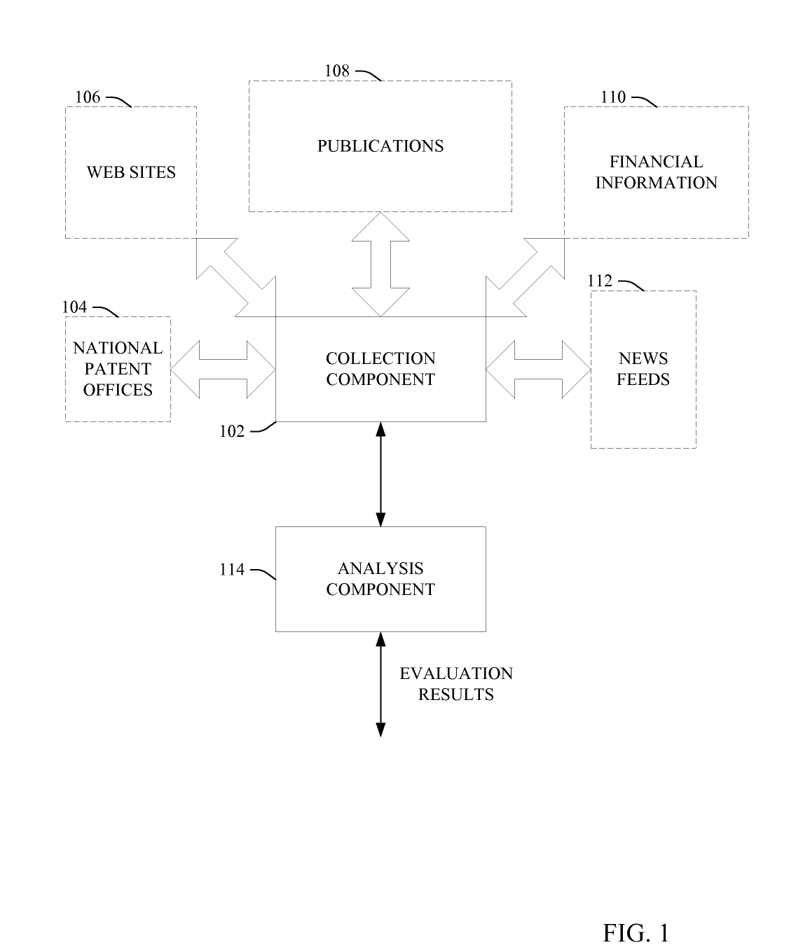

FIG. 1 discloses an example system 100 for determining if a financial opportunity is to be pursued. A relatively large number of financial opportunities can be available for pursuit. However, many financial opportunities have a prospect of producing a relatively small profit; therefore, it is commonly not cost effective to dedicate human resources to pursuit of small financial opportunities, obscure transaction, transactions outside of a typical practice area, etc. Example financial opportunities include supplying a loan to a company that could benefit from added capital, a tax protection scheme for a non-profit organization, asset liquidation of a bankrupt company, re-financing a loan that a company is having difficulty repaying, etc.

According to one embodiment, financial opportunities are investment banking opportunities such as underwriting (e.g., debt or equity), Initial Public Offerings, Merger & Acquisition advising; Private equity; Finance re-structuring, etc. Opportunities can include bringing a company public or bringing a company private, determining which two companies would do better together, which company will do better broken apart, etc. A goal of a financial opportunity can be to receive authorization for an investment bank to represent a client on a matter. Potential financial opportunities (e.g., investment baking opportunities) can be collected via a rules based and/or semantic search engine, Internet browser based application for investment banking, service request capture, Internet browser based application for capturing investment banking opportunity referral, etc.

The system 100 allows for automated financial opportunity evaluation. Through employment of the system 100, fiscal possibilities with a relatively high likelihood of success (e.g., large percentage of being profitable, large profit margin considering possibility size, etc.) can be qualified without extensive human involvement. A collection component 102 obtains information from a network (e.g., a data network, such as the Internet, multiple networks, such as the Internet and an intranet, a data network and an attached storage device, for instance the Internet and removable flash memory, etc.).

Various sources hold information that can be important in determining if a fiduciary transaction should be entered. The following example will be used in portions of the subject specification to describe aspects associated with the disclosed innovation. An investment company located in Charlotte, North Carolina, United States can operate the system 100. The collection component 102 identifies a company that makes specialty ice hockey sticks for handicapped players (hereafter known as ‘the hockey company’) as a construct that could produce a possible financial opportunity. The collection component 102 can use logic, semantic search capabilities, etc. to differentiate between similar or like named constructs (e.g., search both “The Hockey Company” and “Hockey Company, LLC”). In an illustrative instance, use of a semantic search can detect a difference between a “hockey stick company” and “he was in good company with his hokey sticks”. A semantic search would understand a concept of what an investment banking opportunity is against another opportunity type and make selections on information to gather.

The collection component 102 obtains information for various sources that can be used in determining if a financial opportunity should be followed. A national patent office 104 commonly discloses intellectual property held by a company and/or being pursued by a company. The collection component 102 learns intellectual property holdings of the hockey company as well as tentative applications filed by the company. The collection component 102 can use advance search techniques (e.g., trained algorithms) to performed detailed searches. For instance, not only does the collection component 102 identify patents held by the hockey company, but also patents held by subsidiary companies (e.g., companies in which the hockey company holds a majority share).

Information related to the company, such as subsidiary holdings, can be determined through searching of Internet websites 106. The collection component 102 can employ different search techniques in order to obtain information. According to one embodiment, a keyword search is employed to find information that relates to a construct (e.g., common occurrences of a service name for the hockey company). The collection component 102 can use a semantic search to determine information located at different sources. A semantic search can produce a useful result since context of information is taken into account as well as the content of the information. It is to be appreciated that use of a semantic search is disclosed as an example and other implementations can be practiced. The collection component 102 can use gathered information to engage in improved data gathering. For instance, search of a national patent office 104 can yield a product name, and the product name is used in search of websites 106.

A variety of publications 108 (e.g., trade journals, magazines, product reviews, academic articles) can provide useful information concerning a financial opportunity. For instance, a new disabilities law can be proposed at a federal level that requires schools to provide athletic opportunities to disabled children. In addition to the proposed law, various academic articles can debate a likelihood of the law passing as well as anticipated impacts of the law. This information can signal a possible growth opportunity for the hockey company and therefore the information should be obtained.

Many companies have financials 110 made public, either published or through request. Example types of financial information include revenue, profits, debt, share price, share estimated rate of return, analyst opinion (e.g., but, hold, sell, etc.), real property holdings, secured transactions, pending legal actions (e.g., plaintiff, defendant, patent infringement case, product liability case, etc.), etc. Financials are helpful in determining a state of a construct as well as their economic vitality.

News feeds 112 can produce stories that relate to a financial opportunity. The stories can be digested by the collection component 102 in order to determine if the financial opportunity should be pursued. Stories can be related to a company entrenched in the financial opportunity (e.g., the financial opportunity is to re-finance a loan for a company that is the subject of a recent story), an industry, etc.

Obtained information can transfer from the collection component to an analysis component 114. The collection component 102 commonly transfers a subset of information to the analysis component 114 (e.g., an entire set, a portion of a set, etc.). The transfer can takes place across wires, in a wireless manner, through use of security techniques (e.g., encryption), etc.

The analysis component 114 evaluates the obtained information and assesses a financial opportunity based upon a result of the evaluation. In an example evaluation and assessment, a financial prospect can be to provide financing to the hockey company. The financing prospect is structured off a recently issued patent and a public movement to assist individuals with disabilities. There is evaluating the patent (e.g., what is covered by a claims section), evaluating the movement (e.g., donated money to political action groups), and assessing if the opportunity is something that should be pursued based on evaluation results. According to one embodiment, the analysis component 114 evaluates potential opportunities by performing rules based analysis.

Assessment of information determines positive and/or negative influences concerning a fiscal proposal. The hockey company can be requesting a loan to produce a new type of hockey stick. A publication 108 can produce information that disabled hockey competitors have a history of slow change with regards to equipment. Evaluation of the publication information can determine that there is a higher risk for the hockey company's new stick due to industry history (e.g., players are less likely to use a new stick due to a history of loyalty to old equipment). Likewise, a patent from a national patent office 104 of a nation with a market the hockey company wants to chase can have strong protection. This can be seen as a benefit to pursuing the financial opportunity, since if the hockey sticks do become popular, there is a limited amount of likely competition.

The analysis component 114 can output evaluation results in a number of different formats. Raw calculations can be produced; for example, a summation of weights provided to risk factors of different pieces of information. However, output can be in a more structured form; results not only include an evaluation outcome, but also a predictions, such as an expected profit if a deal were pursued, an estimated likelihood that the financial opportunity comes to fruition, etc.

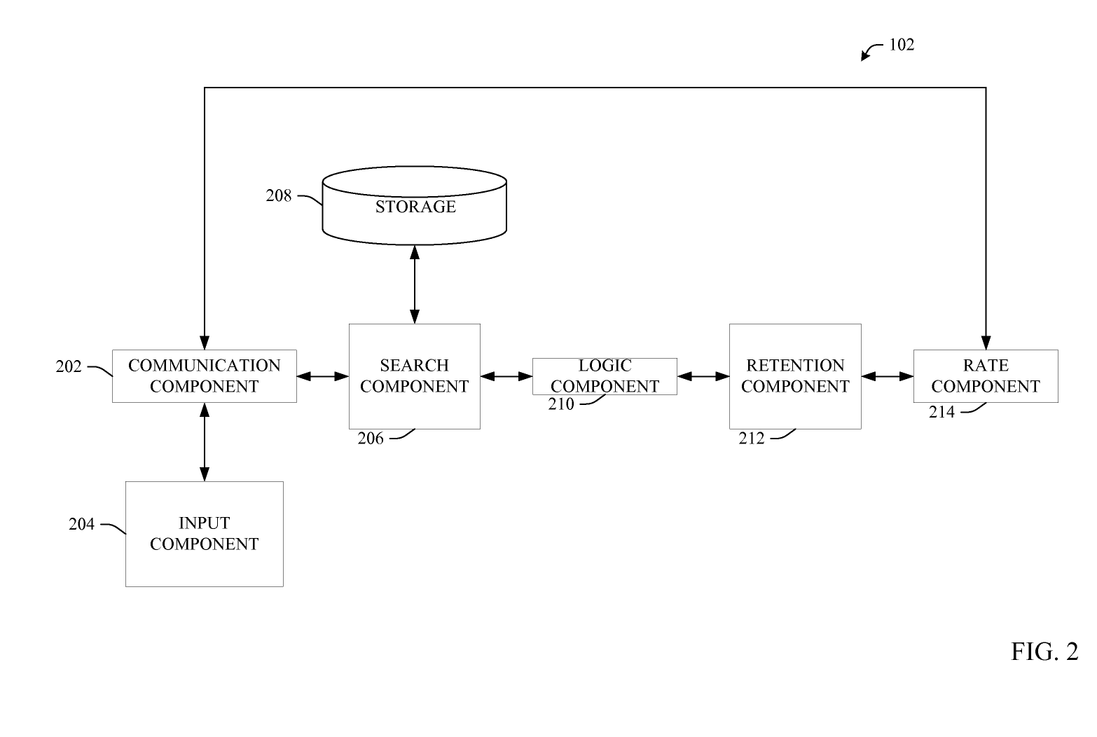

FIG. 2 disclosed an example collection component 102 that obtains information from a plurality of sources. A communication component 202 enables the collection component 102 to interact with other units. The communication component 202 can be utilized to enable devices of the collection component 102 to engage other devices (e.g., a website host) in a wireless manner.

While a large discussion of the subject specification focuses on the collection component 102 seeking out information, information can be obtained in other manners. For example, an input component 204 enables a user to enter information related to a financial opportunity directly into the system 100 of FIG. 1. A vice president of the hockey company can have a desire to list the hockey company on a publicly traded stock exchange. The input component 204 can disclose a questionnaire requesting information related to a financial opportunity. This can be done through displaying a graphical user interface with the questionnaire upon a website of the investment company. A user can answer presented questions (e.g., what is your companies name, what product/service are you seeking, etc.) and the input component 204 receives the answers and transfers the answers to the collection component 102.

A search component 206 enables the collection component 102 to automatically discover information and obtain at least some of the discovered information. The search component 206 can contain various algorithms that perform a semantic search upon data sources. In addition, the search component 206 can utilize supplemental units, such as storage 208 and logic component 210.

Storage 208 allows for holding of data that relates to operation of the collection component 102. It can be more efficient for the analysis component 114 of FIG. 1 receive information in groups as opposed to a continuous stream. The search component 206 can place obtained information in storage 208. When a transmission to the analysis component 114 of FIG. 1 takes place, obtained information is extracted from storage and transferred to the analysis component 114 of FIG. 1 via the communication component 104. In addition, history of searches can be held in storage and the history can be used by the search component 206. In an illustrative example, a hockey message board that at one time produced a large amount of information is now down and cannot be accessed. A record of the message board being down can be held in storage 208 and when future searches take place, the record can be accessed and the message board is not searched.

A virtual endless amount of information can be available for searching by the collection component 102. Searching a body of available information can be not only cumbersome to the collection component 102, but can also consume an undesirable amount of resources (e.g., local storage). Logic component 210 can configure with selection capabilities to determine locations that are likely to produce beneficial information concerning pursuit of a financial opportunity. For instance, searching an athletics equipment review publication is likely to produce more beneficial information for the hockey company then a particle physics doctoral dissertation. Instructions concerning where the search component 206 should discover information can transfer from logic component 210 to the search component 206. Therefore, the collection component 102 can search the review publication before the dissertation, the collection component 102 can choose to ignore the dissertation, etc.

In addition, the collection component 102 to identify financial opportunities from obtained information. Generally, a financial opportunity is not known until at least some information is obtained. The collection component 102 can perform general searches in order to gather information. The general searches can be directed to sources that commonly produce medium to small financial opportunities (e.g., business magazines). Logic component 210 can process gathered information and determine a potential opportunity (e.g., a magazine article stating the hockey company could be filing for bankruptcy could disclose a possible loan opportunity.) When a potential opportunity is identified, logic component 210 can instruct the search component 206 to attempt to specifically gather data on the financial opportunity (e.g., perform a semantic search upon financials of the hockey company). Thus, gathered information is more tailored to a specific financial opportunity.

Since a general populous produces a relatively large amount of obtained information, the logic component 210 can employ different techniques to overcome inherent difficulties. One inherent difficulty can be misspelling of a company name. Logic component 210 of the collection component 102 can identify likely misspellings and perform searches on sources with regard to misspelled terms. Additionally, information can be incomplete and vague, causing the collection component 102 to make a guess related to obtained information. In an illustrative example, the term ‘hockey’ can represent ice hockey, field hockey, broomball, etc.; logic component 210 can use contextual clues to determine what type of hockey is intended in gathered information.

A retention component 212 holds metadata that relates to obtained information. Example metadata includes a path from the collection component to a source of a particular piece of data (e.g., a stock share price). Logic component 210 can indicate that the source of the data should be tagged so changes in information can be appreciated, such as a change in the stock price. The retention component 212 holds a path to the information so changes can be quickly ascertained; the search component 206 can discover where to look for a change. Other examples of metadata include date information became available to the public, size of a related attachment, etc.

A rate component 214 tests quality of obtained information. Since information is gathered from a variety of sources, different pieces of information can have different levels of quality. For example, a review for a stick of the hockey company from a handicapped user is likely of higher quality then a non-player's cosmetic rating of the stick. In addition, some information sources can publish false information, misleading information, information not intended to be used in a serious context, etc. The rate component 214 estimates a quality level of information and quality level can be taken into account by the analysis component 114 of FIG. 1. The communication component 202 can be engaged to transfer obtained information, metadata, etc. to the analysis component 114 of FIG. 1.

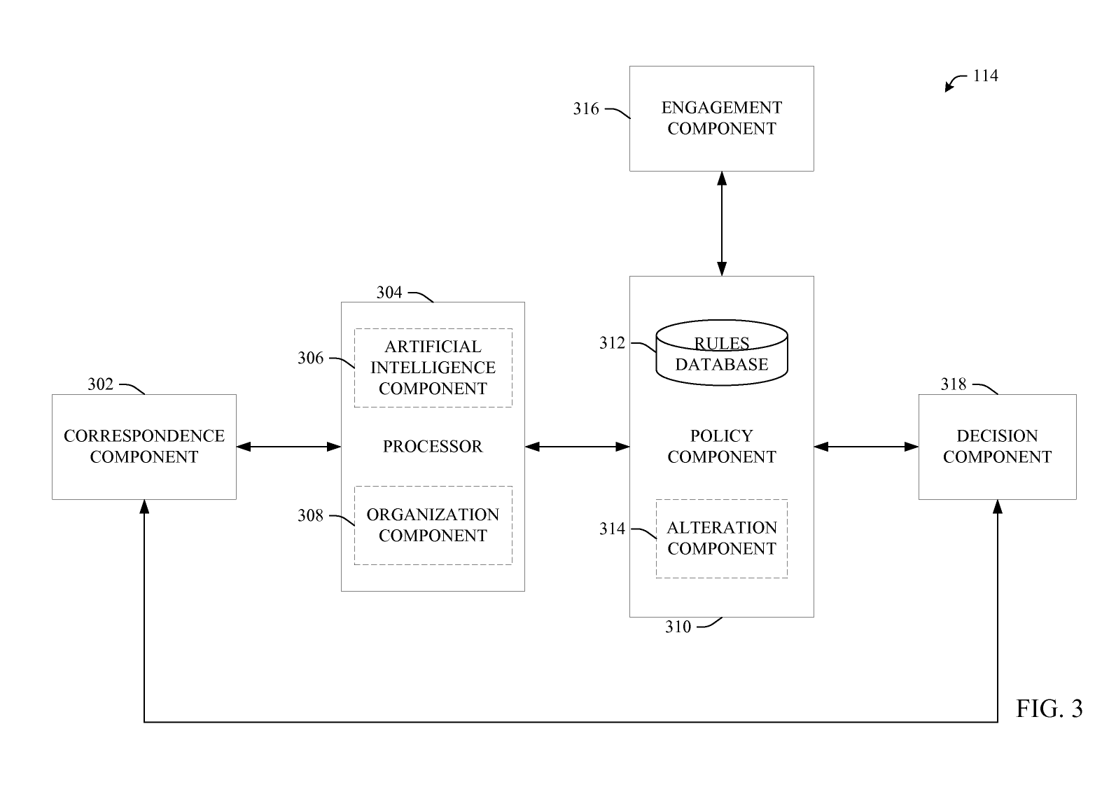

FIG. 3 discloses an example analysis component 114 that evaluates the obtained information as a function of a financial opportunity. A correspondence component 302 receives information obtained from the collection component 102 of FIG. 1. Security features can be implemented by the correspondence component 302, such as checking for errors that can disrupt the analysis component (e.g., viruses), authenticating a sending collection component 102 of FIG. 1, etc.

A processor 304 can perform different operations upon obtained information. The processor 304 can utilize artificial intelligence component 306 in evaluating obtained information. The artificial intelligence component 306 makes at least one inference or at least one determination with regard to the financial opportunity. Various scenarios can occur that are processed by the artificial intelligence component 306. For example, the artificial intelligence component 306 can have an instruction that proper evaluation is not to take place until a set threshold of information has been reached (e.g., twenty pieces of high quality information); a determination is made if enough information has been obtained of a desired level. In another example, initially five pieces of negative information are obtained while no positive information is obtained concerning a financial opportunity. The artificial intelligence component 306 can infer that the financial opportunity is a bad prospect and cancel further evaluation, thus saving system 100 of FIG. 1 resources.

Artificial intelligence component 306 can employ one of numerous methodologies for learning from data and then drawing inferences and/or creating making determinations related to association of a representation (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems. A rules based investment banking product matching software engine, rules based investment banking presentation scheduler engine, and/or automated investment banking pitchbook presentation generation are examples of aspects that can be implemented through artificial intelligence techniques.

In addition to an artificial intelligence component 306, the processor can utilize an organization component 308. Commonly, the collection component 102 of FIG. 1 gathers a vast amount of information; however, the information is not assigned to specific financial opportunities. The organization component 308 determines what information is relevant toward what opportunity. Stock price for the hockey company can relate to one financial opportunity (e.g., a merger and acquisition deal) while a product relate to a different financial opportunity (e.g., financing to increase production). The organization component 308 can assign information to at least on financial opportunity; for instance an academic article on chemical substances can relate to both the hockey company (e.g., a protective coating used on hockey sticks) as well as a home building fiscal prospect (e.g., wood protecting for homes). The organization component 308 associates at least part of the obtained information with the financial opportunity.

A policy component 310 retains rules in a rules database 312; evaluation of obtained information takes place in accordance with at least one held rule. Rules allow the analysis component 114 to make evaluations concerning the financial opportunity. For instance, the rules database 312 can have a regulation that if a company has revenue in a niche market of two million US Dollars, then expanding a product for the company can be considered a good opportunity that should be pursued. The policy component 310 can extract the rule and compare revenue of the hockey company against the revenue rule to evaluate if a financial opportunity is to be pursued.

An alteration component 314 adaptively changes at least one retained rule. When the analysis component 114 is constructed, the two million US Dollar revenue rule can be placed into the rules database 312. However, market conditions can change and the rule can become skewed (e.g., two million US Dollars is no longer an appropriate measuring mark). The alteration component 314 can appraise obtained information to determine that canons of the rules database should be modified and then perform the modification. For instance, similar financial deals suggest that the mark should be moved to three million US Dollars. The alteration component 314 recognizes that the change should be made and alters the revenue rule accordingly.

An engagement component 316 receives user instruction for rules modification, where the policy component 310 implements at least one rule modification upon at least one retained rule. For example, the policy component 310 can apply weights to information that are used by a decision component to determine if a financial opportunity should be pursued. A user can feel that a different weight should be applied (e.g., stock shares should be weighted higher). A user enters the weight change in engagement component 316 and the policy component 310 implements the weight change. The engagement component 316 and the input component 204 of FIG. 1 can manifest as one unit, such as a user computer terminal.

A decision component 318 establishes if the financial opportunity should be pursued. Information can be evaluated according to a number of different rules retained by the policy component 3 10. Evaluation results can be conflicting (e.g., some results state the financial opportunity should be pursued, while other results state there is a low likelihood of a profitable return) and the decision component 318 can resolve conflicts while establishing if a financial opportunity should be pursued. The decision component 318 can operate as a means for selecting if an economic occasion should be chased.

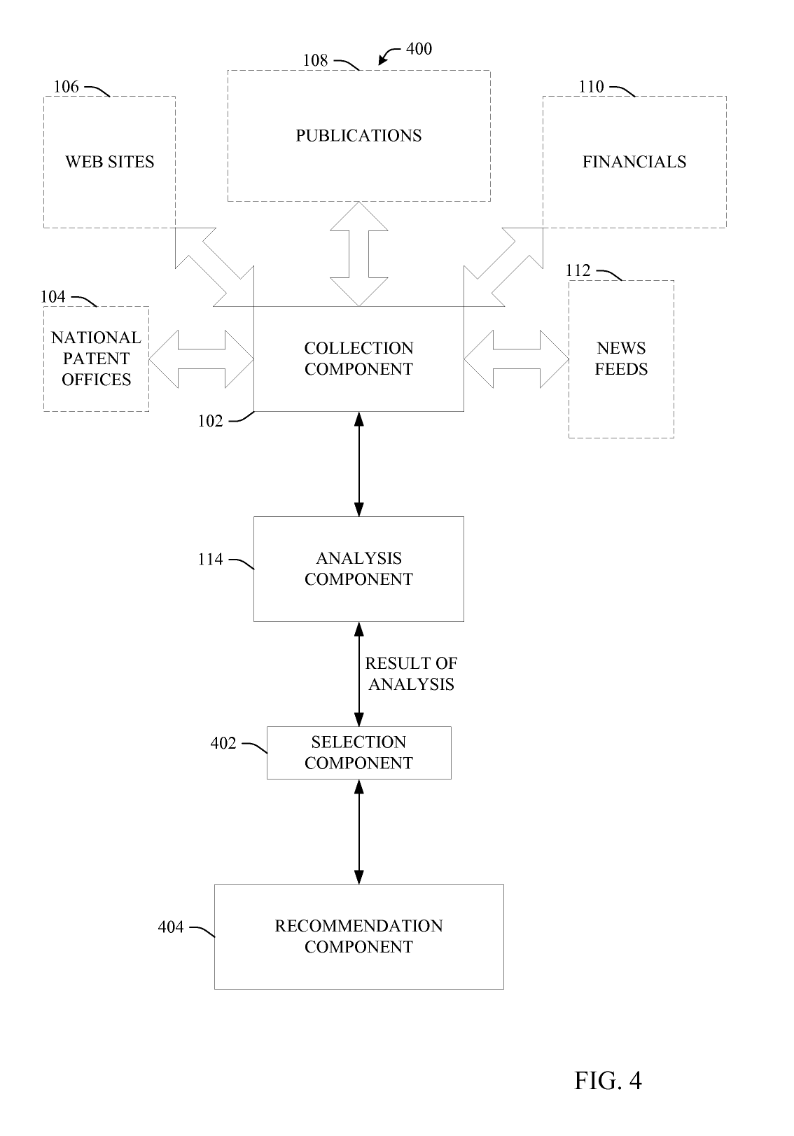

FIG. 4 discloses an example system 400 for determining if a financial opportunity is to be pursued with a selection component 402 and a recommendation component 404. A collection component 102 obtains information from a network. Example sources of obtained information include a national patent office 104, websites 106, publications 108, financials 110 (e.g., a stock exchange ticker), news feeds 112, etc. Analysis component 114 evaluates the obtained information as a function of a financial opportunity.

The selection component 402 ordains an auxiliary provider to pursue a financial opportunity. For a variety of reasons, the analysis component 114 can determine that an indicated financial opportunity should not be pursued. In an illustrative example, the financial opportunity can be to find a large company to merge with the hockey company. However, the hockey company is located in Laval, Quebec, Canada. In Quebec, French language is commonly more accepted then English language and various cultural differences can present problems. It can be difficult for the investment company in North Carolina to have success due to language and cultural differences. Therefore, the selection component 402 chooses a company that is better suited to engage in the financial opportunity.

Ordaining of an auxiliary provider through the selection component 402 can take place according to a number of different embodiments. The investment company can have an existing relationship with a firm in Quebec; if the analysis component 114 determines that the investment company would be unlikely to succeed while an associate firm could succeed, then the Quebec firm is chosen. In another embodiment, the selection component 402 can offer to at least one other company the chance to purchase data that relates the financial opportunity; this can take place through a direct sale, auction bidding, etc. Moreover, the selection component 402 can use weighting algorithms to determine companies that are to be supplied with a financial opportunity. The algorithms can configure to provide a greater amount of financial opportunities to companies that have provided the investment company with the largest beneficial financial opportunities.

The recommendation component 404 refers the financial opportunity to an auxiliary provider. Commonly, this takes place through an electronic notice transferring to the auxiliary provider (e.g., company). However, referrals can be in-house; for example, if a financial opportunity is not pursued by an investment bank division, then it is referred to a commercial bank division, where the investment bank division and commercial bank division are part of one company. A referral produced by the recommendation component 404 can include at least one result of the evaluation. For instance, in addition to stating that there is a loan opportunity to provide money to the hockey company to produce more hockey sticks, details can be provided as to how the analysis component 114 reached that conclusion, such as industry contacts, expected profits, etc. However, the recommendation component 404 can merely provide a referral without detail (e.g., send a notice to a company that there could be a financial benefit to providing loan money to the hockey company for increased production). The recommendation component 404 can operate as a means for referring an economic occasion if it is determined that the economic occasion should not be chased.

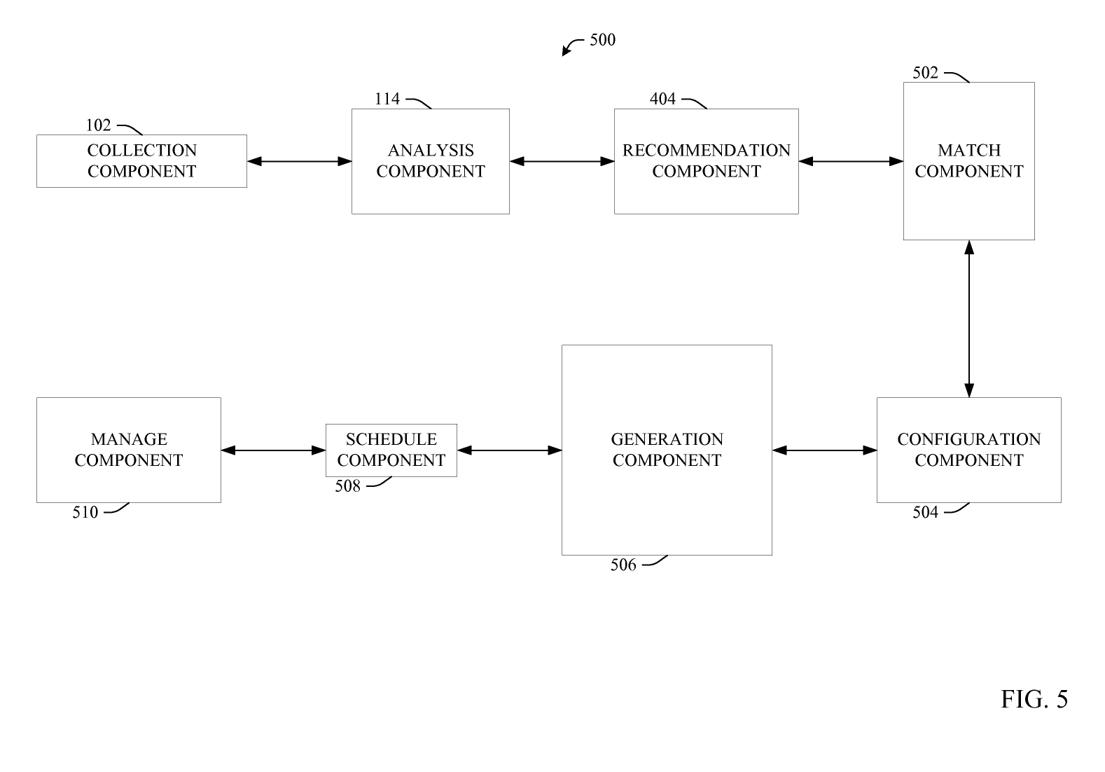

FIG. 5 discloses an example system 500 for processing of a fiscal prospect. A collection component 102 obtains information from a network. Information is typically gathered from a plurality of sources and transferred to analysis component 114 for evaluation. Information can be gathered from a user submission, from monitoring communication traffic, actively searching websites, etc.

The analysis component 114 evaluates the obtained information as a function of a financial opportunity. A set of rules is applied upon obtained information to determine if a financial opportunity should be pursued. The rules can be modified by a user or automatically if desirable results are not being achieved (e.g., bad fiscal prospects are pursued, good financial projects are being rejected, etc.). A decision if the financial opportunity should be pursued is made and the financial opportunity can be held for further observation, disposed, transferred to other portions of the system 500, etc.

If a financial opportunity is not to be pursued by a construct running the system 500, then a recommendation component 404 refers the financial opportunity to an auxiliary provider. The recommendation component 404 can rely on a selection component to choose at least one entity in which the recommendation component 404 can refer a financial opportunity. A recommendation can include evaluation information, however, a mere referral can also be provided.

If a referral does not take place and the system 500 is to continue in pursuit of a financial opportunity, then a match component 502 operates. The match component 502 selects at least one product or service for engagement of a fiscal possibility, commonly based off a result of the analysis component 114. A company can desire to gain capital to increase production. One option can be to take out a bank loan while another option can be to generate capital by taking the company public. The match component 502 selects a product or service that is appropriate for pursuit of the fiscal possibility. According to one embodiment, the match component 502 find a maximum combination of at least one service or at least one product (e.g., maximize profit for an investment firm, maximize profit as a function off hours spent, increase likelihood fiscal possibility will not operate at a loss, etc.).

A configuration component 504 arranges at least one parameter related to the selected product or service. Based on an outcome of the match component 502, a selected product or service has parameters that are to be established. For instance, the match component 502 can select a loan for providing capital to a company. The configuration component can establish term of the loan, interest rate of the loan, suggest collateral for the loan, etc.

Knowledge of a product or service for user can be useful in creating a presentation. A generation component 506 creates a presentation that relates to the fiscal possibility based upon the obtained information. A presentation can be used to convince a client to engage in a transaction with an investment firm operating the system 500 (e.g., allows the investment firm to gain benefits of the financial opportunity). While stated as being operated by a company pursuing a financial opportunity, it is to be appreciated that aspects of the subject specification can take place by a third party on behalf of an entity (e.g., investment company). Example presentations include digital slide arrangements, folders, pamphlets, videos, sketch drawings, etc.

A schedule component 508 organizes time of at least one person as a function of a fiscal possibility, where the person with organized time relates to the created presentation. While a presentation generates automatically, it can be beneficial to have at least one individual designated to disclosing the presentation to a prospective client. In addition, the schedule component 508 can designate a person to supervise a financial opportunity. The schedule component 508 can view metadata relating to different people based on analysis of the metadata, a person can be designated to a financial opportunity and a portion of their time can be allotted to the opportunity. For instance, the schedule component 508 can view time allotments, priority notices, previous experience, etc. in determining an individual to designate to a project (e.g., designation by filling calendar time for a person with time for the financial opportunity).

A manage component 510 regulates at least one auxiliary task associated with the presentation. Commonly, a number of different tasks take place following disclosure of a presentation. Example tasks include transmitting follow-up correspondences, scheduling supplemental telephone calls, docketing events that occur after the presentation, etc.

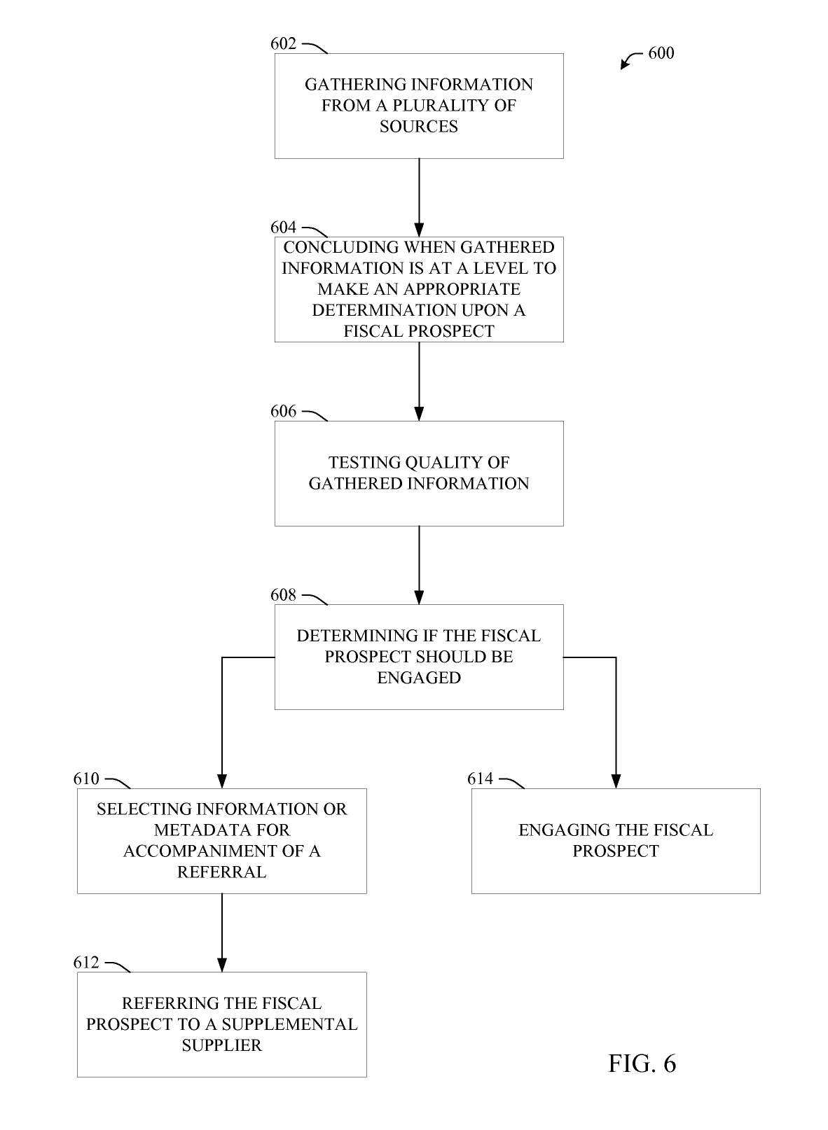

FIG. 6 discloses an example methodology 600 for finding and evaluating financial opportunities. There is gathering information from a plurality of sources 602 (e.g., executing a semantic search upon sources). Sources hold information that can be used to determine a possible financial opportunity as well if the financial opportunity should be pursued. Gathering can take place via searching storage locations, passively monitoring a network (e.g., a data network), receiving input from a user, etc. While searching a plurality of sources commonly produces a quality result, it is to be appreciated the methodology 600 can be practiced by obtaining information from a single source, such as running a semantic search upon a comprehensive database. Gathering information from a plurality of sources can include identifying a potential opportunity and associating gathered information with the opportunity.

Concluding when gathered information is at a level to make an appropriate determination upon a fiscal prospect 604 occurs. Gathering information can come about upon a near infinite number of sources and thus take a near infinite amount of time. For practical purposes, once a set amount of information is gathered, evaluation can take place. Therefore, an amount of gathered information concerning a financial opportunity is compared against a set threshold (e.g., gathered information consumes one gigabyte in storage.) If a threshold is reached, then other actions of the methodology 600 can occur even though other information could become available. If an appropriate level of information has not been gathered, then the methodology 600 can continue gathering information and re-operating event 604.

Event 606 is testing quality of gathered information. Information from a plurality of sources can have different quality levels. For instance, a hockey stick review from a hockey magazine is probably of higher quality (e.g., clear description, unbiased, etc.) then a web log review by a pre-teenager. Learning quality of information allows weights to be placed on information, where higher quality (e.g., more reliable) information is supplied with a higher weight.

Determining if the fiscal prospect should be engaged 608 takes place. Ultimately, a financial opportunity is to be pursued or is to be rejected. A determination is made based on gathered information, commonly in light of quality of the gathered information. Act 608 can take place through applying a set of rules upon gathered information associated into a construct (e.g., data bundled together that relates to a company). As the set of rules (e.g., about one or more rules) are applied, outcomes of the rules can be used to make a final determination. For example, a rule can state if a financial opportunity is in an expanding market defined as a sector that has experienced yearly growth of at least about 5% each of the last about three years, then the fiscal prospect should be followed. Outcomes of rules can be assigned a numeric value (e.g., positive values for a prospect that should be pursued, negative values for those that should not be pursued) and added together. A vastly negative number can be dismissed and the financial opportunity is no pursed. However, act 608 can allow for an internal pursuit of the fiscal prospect or a pursuit by an external entity (e.g., another person, department, company, etc.).

The fiscal prospect can be referred to another entity, and thus there is selecting information or metadata for accompaniment of a referral 610. In order for an entity to appreciate a fiscal prospect, information concerning the prospect commonly transfers to the entity. For instance, a name of a construct relating to the fiscal prospect and a prospect type can be selected. In addition, metadata can transfer to another entity so the entity can have an improved understanding of the fiscal prospect (e.g., projected profit, process used in determining validity of fiscal prospect, etc.) and a greater likelihood of success.

Referring the fiscal prospect to a supplemental supplier 612 occurs. Typically, referring sends a notice to another entity concerning the fiscal prospect, such as sending the selected information and/or metadata. Referrals can be sent to multiple supplemental suppliers that have paid a fee to receive the information and/or metadata. Moreover, a look-up can be performed to determine other entities that have made referrals to an investment firm running the methodology 600. Based on a result of the look-up, entities that have provided recommendations can receive referrals.

Action 614 is engaging the fiscal prospect when a primary entity (e.g., company running the methodology 600, organization that has the methodology 600 running on the organization's behalf, etc.) is to pursue the fiscal prospect. Engagement can include taking a step toward execution of the fiscal prospect (e.g., creating a notice, making a schedule, recording that the fiscal opportunity is to be pursued, generating a presentation, etc.). When an engagement takes place, a record can be stored in a docket system to others can appreciate what is being pursued.

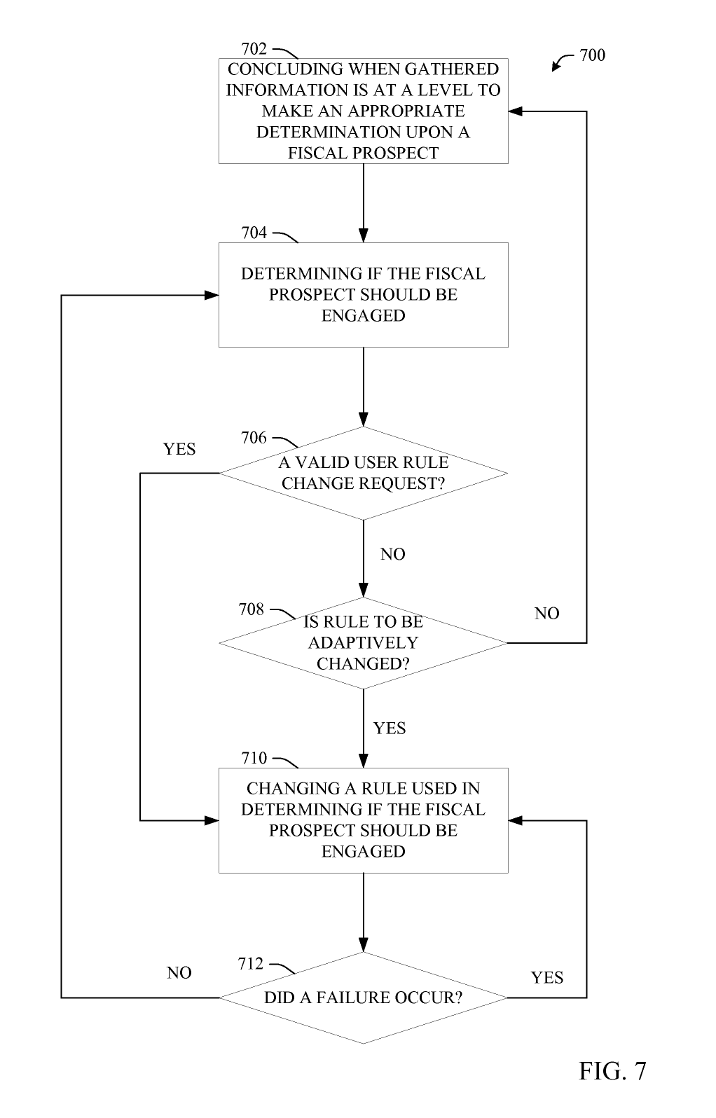

FIG. 7 discloses an example alteration of rules methodology 700 disclosing aspects that can be used in changing logic used in determining if the fiscal prospect should be engaged. There is concluding when gathered information is at a level to make an appropriate determination upon a fiscal prospect 702. Commonly, a large amount of information can be gathered that relates to a fiscal prospect. However, it is possible that gathered information is not highly relevant, of a substantial quality, at a desirable detail level, etc. Therefore, action 702 determines when there is enough information to make an accurate decision. A standard is reviewed (e.g., a standard saved in storage, downloaded from the Internet, etc.) and a comparison against the standard with gathered information determines a result. The result discloses if enough information has been collected. For instance, a standard can be twenty pieces of high quality information (e.g., as determined by a rate component 214 of FIG. 2) as an appropriate level. Action 702 determines compares gathered information against the standard and draws a conclusion if the information is at an appropriate level.

Determining if the fiscal prospect should be engaged 704 occurs. Generally, a fiscal prospect is engaged in order to provide a benefit to a construct (e.g., financial gain, goodwill, etc.). If a financial prospect does not have a relatively high potential to providing a benefit, then it is generally not pursued. The determination can be made based on a complex algorithm using rules based upon construct desires, market trends, estimations and calculations, risk potential, ethical decisions, etc.

There is reception of a request from a user to change a rule and a determination if the user request is valid 706. If a result is produced that is not desirable to a construct (e.g., a relatively high number of fiscal prospects are being rejected), then a user can send a request to modify a rule. For instance, a user can request that due to a cooling market that fiscal prospects with higher associated risks should be pursued.

Check 708 determines if a rule is to be adaptively changed. For instance, a system operating the methodology 700 can determine that too many financial opportunities are being accepted that ultimately turn out to be unprofitable. A determination can be made that in order to accept a fiscal prospect, a minimum company revenue must be achieved by a company involved in the fiscal prospect.

If no changes are to be made on rules from the user or adaptively, the methodology 700 can return to event 702. There is changing a rule used in determining if the fiscal prospect should be engaged 710 when changes are selected (e.g., from checks 706 and/or 708). Changing rules can include altering parameters of the rule, adding new rules, deleting rules, etc. While the methodology 700 discloses that if a user request is made, then adaptive changes are skipped, it is to be appreciated that other configurations can be practiced. In an illustrative example, both user requests and adaptive requests can be applied to a rules database. An additional act can be included that rectifies inconsistencies between rule change requests (e.g., a user request desires to increase a minimum revenue while an automatic request attempts to decrease a minimum revenue).

Check 712 determines if a failure occurred do to modification of a rule. When modifications of rules takes place, undesirable implications can manifest that should be corrected. In one instance, a change in a rule causes a system computer failure. The check 712 can also determine if a failure would occur in a full implementation through application of a proposed change in a temporary storage holding a copy of a rules database. If a failure did not occur (e.g., no failure occurred, a failure did not occur that caused a serious error, a small error occurred that does not rise to a failure classification, etc.), then the methodology 700 can return to event 702.

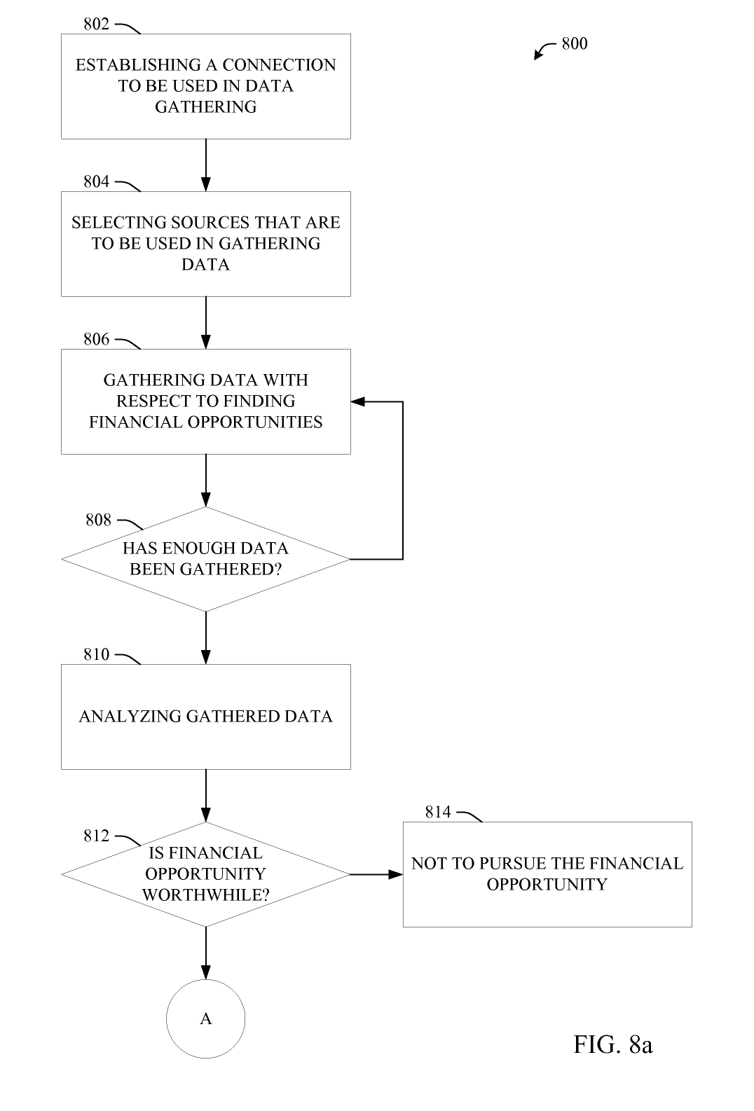

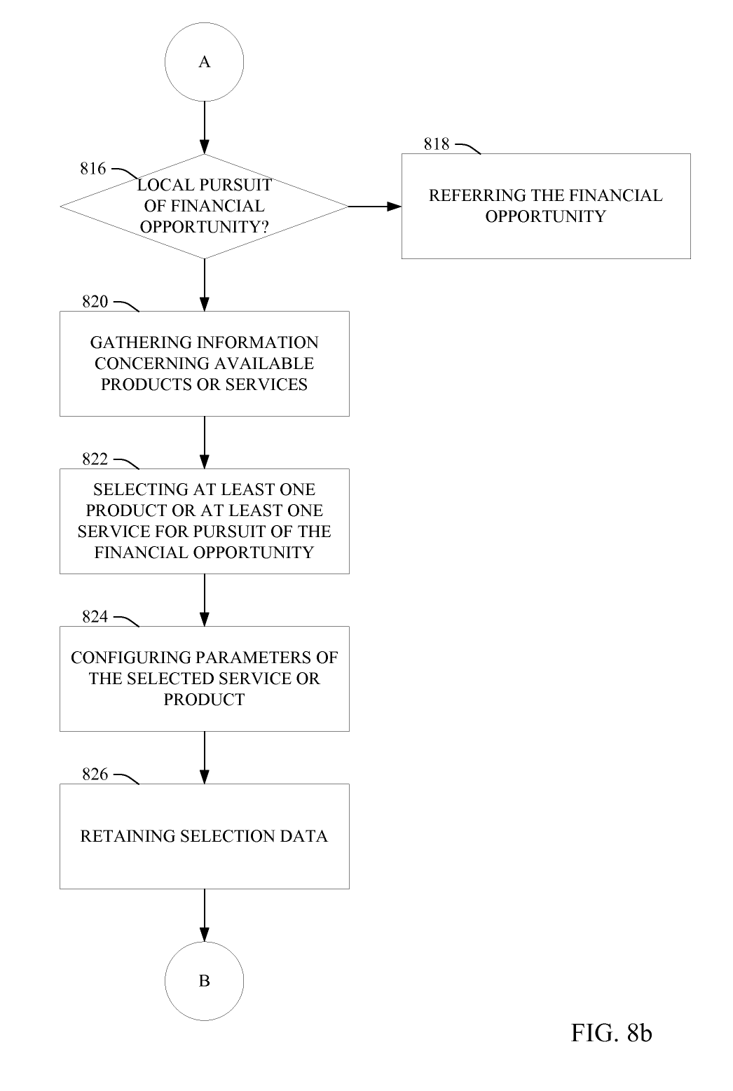

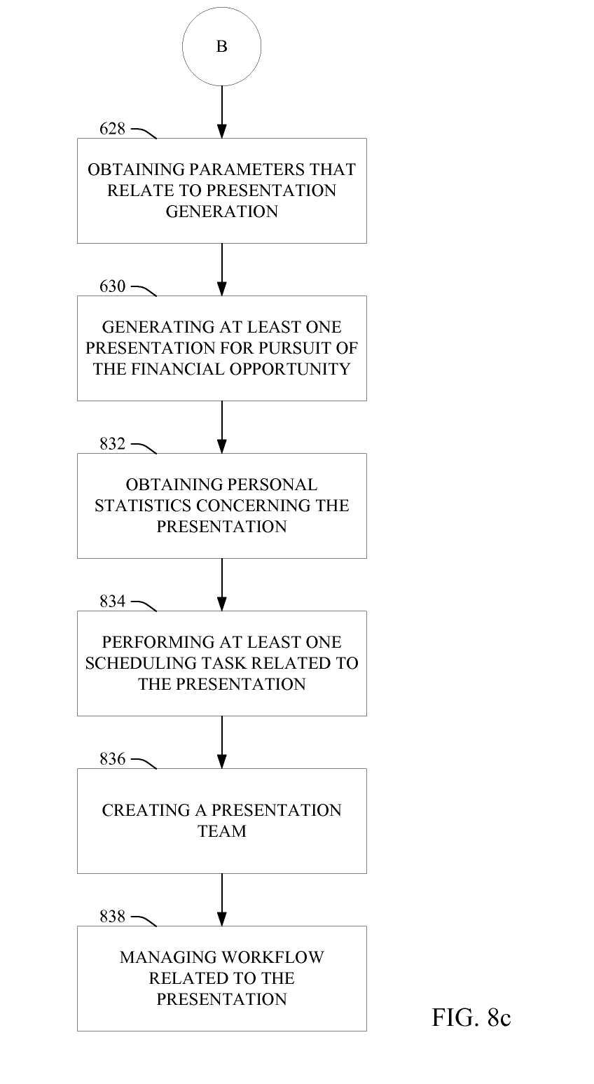

FIG. 8a, FIG. 8b, and FIG. 8c disclose an example methodology 800 for performing actions upon a financial opportunity. There is establishing a connection to be used in data gathering 802. In order to gathered data, it is common to establish an electronic link to allow for information gathering. Example connections include “logging-on” to the Internet, configuring with a monitor to receive user input, integrating with a scanner to receive optical images of information, etc.

Selecting sources that are to be used in gathering data 804 occurs. A large number of sources transferring information to a system operating the methodology 800 can become overwhelming and slow down system operation. To minimize consumption of system resources in information gathering, some sources can be eliminated as suppliers of information. For instance, a financial report website can be signaled as a source that historically produces quality information; therefore, the financial report website is selected for data gathering. However, a social networking website can produce little information on financial opportunities, so the social networking website is deselected for information gathering (e.g., information is not gathered from the social networking website).

Gathering data with respect to finding financial opportunities 806 can take place. Data obtainment can occur according to a number of different embodiments. Passive observance of communications occurs, where observed communications are subjected to a semantic search. Information sources can be actively scoured according to a semantic search to determine relevant information that is then extracted. Receiving communications intended to be included in gathered information, such as an input request from an entity (e.g., filling out a form presenting a financial opportunity), can be obtained. It is to be appreciated that other obtainment configuration can be practiced to gather information.

A check 808 takes place to determine if enough information has been gathered to perform an accurate evaluation of the financial opportunity. An amount of information is compared against an established standard. For instance, a system operating the methodology 800 can have a standard that if a fiscal prospect has an expected profit of about $1,000,000 US Dollars, then about fifty pieces of any quality of information should be gathered for the check to be cleared. If enough information has not been gathered, then the methodology 800 can retract to event 806 to gather more information (e.g., gather enough information to be accepted by the check 808).

There is analyzing gathered data 810; rules are applied against a subset of gathered data and various inferences and determinations are made as a result or application of the rules. In an illustrative example, a subset of gathered data that is the whole set is applied with a rule disclosing that if three or more U.S. patent applications are filed towards a product, then there is a high likelihood there is licensing potential. Therefore there can be an indication that a related financial opportunity (e.g., financing a loan for production of the product) is worthwhile.

A verification 812 determines if a financial opportunity is worthwhile to pursue. A variety of different factors can be taken into account to determine if a fiscal prospect with a worthwhile endeavor. For instance, results of analyzing gathered data 810 can be provided a numerical result (e.g., positive for results that indicate the opportunity should be pursued, negative if the opportunity should not be pursued). Numerical results can be summed together and a final number can indicate if the opportunity should be pursued.

A result of the verification 812 can be relative low and thus the methodology 800 instructs a system not to purse the financial opportunity 814. Action 814 can be a permanent conclusion as well as a temporary conclusion. As a permanent conclusion, the financial opportunity is disposed of and no longer considered active. A message can be transferred indicating the financial opportunity should not be re-evaluated. However, action 814 can transfer back to 806 where more information is gathered and further evaluations take place.

A check 816 can take place to determine a party that should pursue the financial opportunity. While a fiscal prospect can be beneficial, there are possible situations that would make local pursuit too risky, difficult, etc. For example, a fiscal opportunity with a projected razor thing profit margin could be too risky for pursuit of a large investment firm. However, smaller firms can desire to pursue the low profit margin deals and the large investment firm can refer the financial opportunity to smaller firms who pay a fee (e.g., a monthly fee to receive a referral list).

There is typically referring the financial opportunity 818 to another party. This often takes place when there is not to be local pursuit; however, it is possible for there to be both local pursuit and a referral. Referral can take place to at least one or more entities where the referral includes limited information (e.g., opportunity and critical information, such as company name) as well as detail information about the opportunity (e.g., why the opportunity is considered worthwhile, why a firm operating the methodology 800 is not pursing the opportunity, etc.). A record can be made in storage concerning a party that received a referral as well as how they responded to the referral (e.g., did the party purse the referral).

There is gathering information concerning available products or services 820 (e.g., available investment banking products or services). If a financial opportunity is to be pursued, then certain products and or services can be used to improve (e.g., maximize) an outcome for the financial opportunity. A database can be accessed of available products and service and a list can be provided containing different possibilities. If a company would like to develop a franchise model where investors purchase franchise rights to run a company branch in an area, then a possible product can be a loan for investors to cover a franchise fee. If a company is having accounting difficulties, then a software product can be recommended that allows the company to streamline accounting procedures.

Selecting at least one product or at least one service for pursuit of the financial opportunity 822 takes place (e.g., available investment banking products or services); the selection can take place automatically though trained logic. A number of factors can be used in determining an appropriate service and/or product. For instance, a construct related to the financial opportunity can be operating on a limited budget. Therefore, choices are made with total cost of products/services in mind. However, if a company is small, then a combination of too many products and/or services can be overwhelming, so an attempt can be made to select a single product or service so pursuit does not become overcomplicated.

Configuring parameters of the selected service or product 824 takes place. A variety of parameters can associate with a selected product and/or service; these selected parameters can be influential in determining if a financial opportunity is realized (e.g., a potential clients purchases a selected product and/or service). For example, if a loan is selected as a product, the interest rate on the loan can determine success of the financial opportunity. If the interest rate is too high, then the client could be unlikely to purchase the produce. However, if the interest rate is too low, then the financial opportunity can become unprofitable and/or become wasteful (e.g., resources are dedicated to this financial opportunity while the resources could have been dedicated to a more fruitful fiscal prospect). Therefore, event 824 can attempt to configure the selected product/service in manner that improves usefulness of the financial opportunity.

There is retaining selection data 826 that enables monitoring of an outcome for the financial opportunity. If a parameter was selected and an undesirable outcome was achieved (e.g., a selected product and/or service was not purchased by a potential client relating to the financial opportunity), then there can be an indication that a parameter was incorrectly selected. Parameter selection logic can be modified in order to produce improved results. Testing of modifications can take place (e.g. parameter selection logic modification, rule alteration, etc.) in order to improve results.

Action 828 is obtaining parameters that relate to presentation generation. In order to explain a manner in which a financial opportunity will be taken advantage of, a presentation is used to convey information. To create a beneficial presentation, parameters should be learned that could be used in creating the presentation. For instance, if a loan is to be provided to a group of deaf individuals, then sounds would likely not be useful and a parameter would be that sound should not be included in the presentation. Additionally, if a presentation is to be provided over a teleconference, action 828 can obtain parameters that relate to equipment that will be used in the teleconference (e.g., telephones without video capabilities, telephones with poor sound detail communication, etc.). Parameters can be that visual effects should not be used and high detail sounds should not be used since they will likely not be conveyed by the equipment.

There is generating at least one presentation for pursuit of the financial opportunity 830. A common presentation includes gathered information, inferences made from gathered information, statistics and probabilities that relate to the financial opportunity, suggested and alternative products and services, etc. Example presentations include computer slide shows, pamphlets, pitchbooks, etc. A system operating the methodology 800 can use internal logic mechanisms to determine how to configure the presentation in view of obtained parameters.

Obtaining personal statistics concerning the presentation 832 occurs. In a company, different employees can have varying backgrounds, experiences, contacts, skill sets, etc. Event 832 gathers statistical information for at least one person; statistics disclose different traits related to a person. If an individual has a history of closing small financial opportunities for a profit though mechanisms disclosed in the subject specification, then information concerning the success is gathered and used in other actions to attempt to place the person on a proper team.

Event 834 is performing at least one scheduling task related to the presentation. Various scheduling capabilities can become important when determining how a presentation can be disclosed. For instance, conventionally it can be beneficial for a Chief Executive Officer (CEO) to disclose a presentation. However, many CEOs have limited amounts of time and cannot dedicate time to small transactions. Therefore, a scheduling task can be to evaluate priority of time scheduled to a person and determining if the person can be dedicated to the presentation (e.g., slotted to disclose the presentation).

Act 836 is creating a presentation team, where a team is one or more individuals and/or entities. A team is created that divulges the presentation (e.g., three people lead a discussion with the presentation as a guide, one person arranges meetings and makes initial contacts while another provides the presentation, a single person discloses the presentation, etc.) The created team is conventionally a function of characteristics of individuals, parameters of the presentation, scheduling constraints, etc. A team can also include equipment that is specifically dedicated to a team (e.g., a laser printer that the team can use in manufacturing a generated presentation.)

There is managing workflow related to the presentation 838. There can be a number of duties that relate to a presentation. For example, once a presentation is provided, follow-up correspondences can attempt to close a financial transaction. Event 838 can determine what should be done, what can be performed automatically, individuals (e.g., members of the team, support staff, etc.) that should perform specific workflow tasks, etc. Management can be dynamic that allows for changes as situations change.

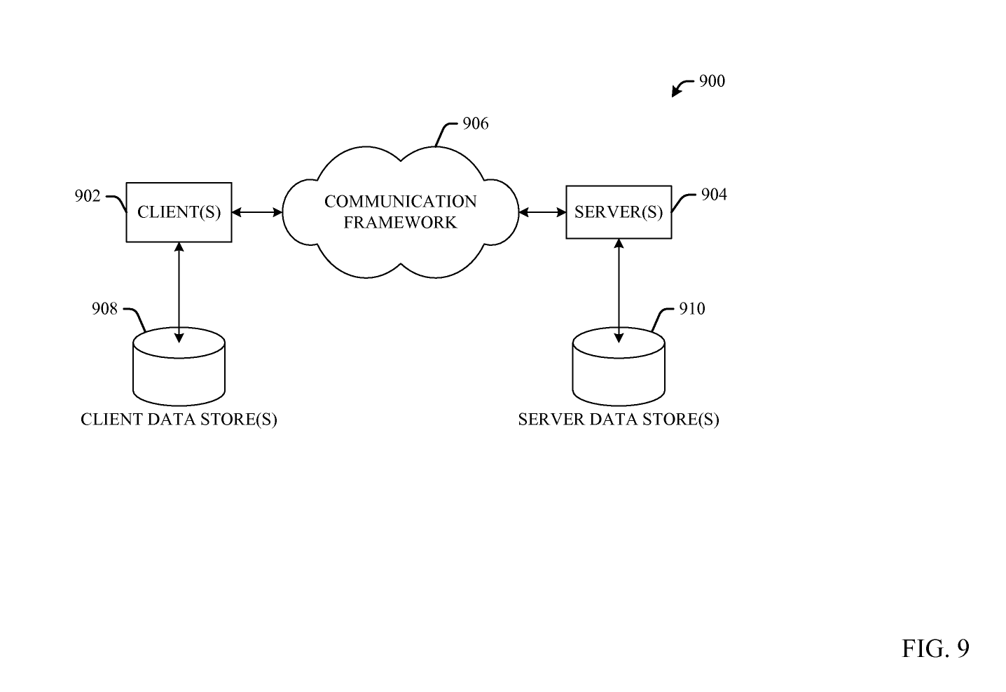

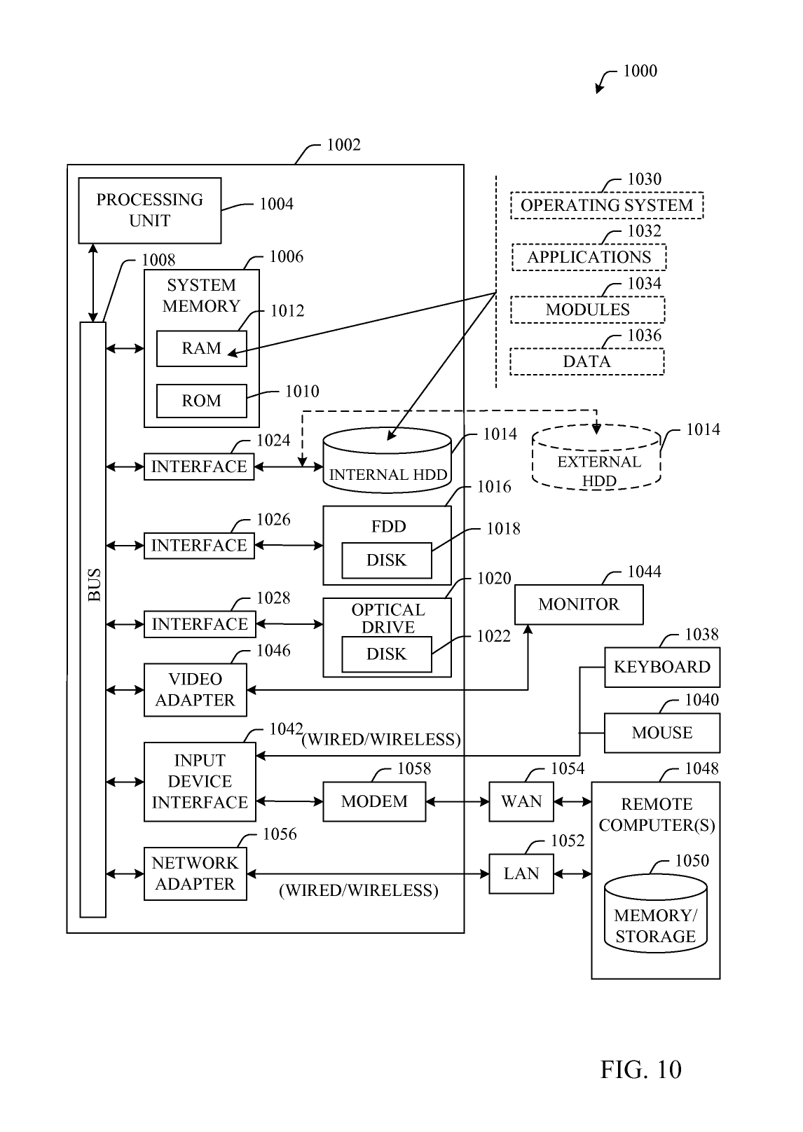

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a collection component that obtains information from a network; and
an analysis component that evaluates the obtained information and assesses a financial opportunity based upon a result of the evaluation; wherein the evaluation relates to whether the financial opportunity is of interest to a financial organization based at least in part upon evaluation criteria employed by the financial organization.

2. The system of claim 1, wherein the collection component obtains information through utilization of a semantic search.

3. The system of claim 1, further comprising a logic component that identifies the financial opportunity.

4. The system of claim 1, further comprising a recommendation component that refers the financial opportunity to an auxiliary provider.

5. The system of claim 4, further comprising a selection component that ordains the auxiliary provider.

6. The system of claim 4, wherein the referral includes at least one result of the evaluation.

7. The system of claim 1, further comprising an organization component that associates at least part of the obtained information with the financial opportunity.

8. The system of claim 1, further comprising an artificial intelligence component that makes at least one inference or at least one determination in relation to the financial opportunity.

9. The system of claim 1, further comprising an input component that receives information from a user, wherein received information is obtained by the collection component.

10. The system of claim 1, further comprising a policy component that retains rules, wherein evaluation of obtained information is performed in accordance with at least one rule.

11. The system of claim 10, further comprising an alteration component that adaptively changes at least one retained rule.

12. The system of claim 10, further comprising an engagement component that receives user instruction for rules modification, wherein the policy component implements at least one rule modification upon at least one retained rule.

13. The system of claim 1, further comprising a decision component that establishes if the financial opportunity should be pursued.

14. A method, comprising:
concluding when gathered information is at a level to make an appropriate determination upon a fiscal prospect; and
determining if the fiscal prospect should be engaged, wherein the determination is based at least in part on the gathered information, wherein the determination relates to whether the financial opportunity is of interest to a financial organization based at least in part upon determination criteria employed by the financial organization.

15. The method of claim 14, further comprising referring the fiscal prospect to a supplemental supplier.

16. The method of claim 15, further comprising selecting information or metadata for accompaniment of the referral.

17. The method of claim 14, changing logic used in determining if the fiscal prospect should be engaged.

18. The method of claim 14, further comprising testing quality of gathered information, wherein at least one testing result is used in determining if the fiscal prospect should be engaged.

19. The method of claim 14, further comprising gathering information from a plurality of sources.

20. A system comprising:
means for determining if an economic occasion should be chased; wherein the determination relates to whether the financial opportunity is of interest to a financial organization based at least in part upon the determination criteria employed by the financial organization; and
means for referring the economic occasion to another entity if it is determined that the economic occasion should not be chased.
